(19) United States
(12) Patent Application Publication
(10) Pub. No.: US 2008/0186621 A1
(43) Pub. Date: Aug. 7, 2008

(54) Disk Drive Fly Height Monitoring Arrangement and Method

(76) Inventor: Charles Partee, Lyons, CO (US)

Correspondence Address: PRITZKAU PATENT GROUP, LLC, 993 GAPTER ROAD, BOULDER, CO, 80303, US

(21) Appl. No.: 11/671,044

(22) Filed: Feb. 5, 2007

(51) Int. Cl. G11B 33/14

(52) U.S. Cl. 360/97.02

(57) ABSTRACT

An exemplary embodiment providing one or more improvements includes a temperature sensing apparatus and method in a disk drive in which a temperature sensor is exposed to a disk induced flow that is generated by the rotation of the disk in the disk drive. The flow changes at least in proportion to pressure changes in the gas environment of the disk drive, to produce a sensor output that is responsive to a pressure change in the gas environment.

### BACKGROUND

The present application is related generally to the field of disk drives and, more particularly, to disk drives having an airbearing that provides a spaced apart relationship between the disk and one or more transducers that are supported by the air bearing where a fly height of the airbearing changes responsive to interior gas pressure in the disk drive.

Driven by a continuing demand for ever-increasing amounts of information storage in an ever-decreasing volume, there is an ongoing trend to reduce dimensions in the hard disk drive recording system.

Included in this trend is the magnetic spacing between the magnetic layer in the disk, that records the data, and the magnetic transducer or transducers, that read and write data using the magnetic layer. It is noted that current airbearing designs establish a fly height that allows the transducers to fly within several nanometers of the disk. In this regard, the magnetic spacing can be somewhat greater than the distance between the surface of the disk and the transducers, as a result of the presence of one or more layers on the disk that overlie the magnetic layer. However, because the airbearing establishes the fly height responsive to air density, the fly height is sensitive to ambient temperature and pressure changes. That is, the airbearing and, thereby, the transducers, will fly highest at cold temperatures, low altitudes, and in the relatively higher pressure of sunny weather. In contrast, the airbearing and transducers will fly lowest at high temperatures, high altitude and in the relatively lower pressure of a stormy weather system.

One approach that has been taken by the prior art, in attempting to cope with this problem, resides in designing airbearings that are insensitive to air pressure changes caused by changes in temperature and barometric pressure (including altitude changes). While this can be accomplished, it is at the expense of increasing sensitivity of the fly height to other parameters. For example, one known way to reduce the air pressure sensitivity is to design the slider so that it decreases in pitch as air pressure decreases, thereby increasing the separation between the read/write transducer and the magnetic layer. However, a air bearing operating at lower This can lead to a less stable airbearing under a mechanical shock condition. In general, a solution is chosen that is ideal for neither air pressure sensitivity nor mechanical shock robustness but represents a compromise between the two issues.

Another popular approach, that has been taken by the prior art, is to fly sufficiently high such that the transducers, at least generally, never touch down on the surface of the disk. While this effectively avoids contacting the disk surface with the air bearing and transducers, performance of the disk drive is compromised under nominal conditions to margin against extreme conditions. In other words, the fly height under normal conditions will necessarily be so high as to significantly degrade the read/write performance of the drive. Accordingly, this approach is considered to be unacceptable. Further, it is recognized that there will be some lower limit on pressure, below which the air bearing simply can not fly.

One recent advance in the prior art has provided a partial solution in coping with these characteristics of the air bearing. In particular, a technique generally known as Dynamic Flyheight (DFH), can force the active area of the transducer relatively closer to the magnetic recording medium or, conversely, relatively further from the recording medium for a given fly height of the airbearing. This is referred to as DFH actuation. To force the transducer closer to the magnetic layer, the DFH actuation is increased. To move the transducer further away from the magnetic layer, the DFH actuation is decreased. When coupled with knowledge of the air density in the drive, the magnetic spacing can be dynamically adjusted according to air pressure changes. At first blush, it would seem that the addition of a pressure sensor would provide an essentially complete solution. Unfortunately, however, it is generally accepted that pressure sensors can be expensive and, therefore, sometimes, not suitable for drives intended for the consumer electronics market. Accordingly, there remains a need for a solution that does not require a pressure sensor.

Another prior art approach in attempting to provide a solution, while avoiding the use of a pressure sensor, uses a thermistor in the drive. Such a thermistor can be small surface mount type. With such a thermistor, the drive is able to measure its in-drive air temperature. Since the dependence of air pressure on temperature is approximately known, it is possible to adjust the DFH actuation accordingly to attempt to maintain a constant magnetic spacing. That is, the DFH actuation is reduced when the temperature is high, and the DFH actuation is increased when the temperature is low. In this case, however, margining for barometric changes and altitude is still required, if it is desired to provide protection vis-à-vis these variables.

Still another approach is to attempt to measure the fly height or magnetic spacing in real time. Such an approach presents significant challenges and introduces significant complexity in what is believed to be the state-of-the-art.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a disk drive includes a disk that is supported for rotation in a housing. At least one major surface of the disk is used in storing data, and a slider is supported for movement, in the housing, relative to the major surface area. A transducer arrangement on the slider is used in performing disk accesses as one or both of a write operation to write data to the disk and a read operation to access data from the disk. The slider is configured for flying in a spaced apart relationship with the major surface during the disk accesses based on a gas environment that is present in the housing, which gas environment can change in pressure such that a fly height of the slider changes with the pressure change in the gas environment. A temperature sensor is positioned proximate to the disk such that the rotation of the disk creates a flow in the gas environment to which the temperature sensor is exposed, and which flow changes at least in proportion to the pressure change in the gas environment, to produce a sensor output that is responsive to the pressure change in the gas environment. In one feature, the slider supports the head arrangement having a magnetic spacing adjustment for selectively adjusting a magnetic spacing between the head arrangement and the major surface for any fly height of the slider and a control arrangement receives the sensor output and changes the magnetic spacing adjustment based on the sensor output. In another feature, a reference temperature sensor is placed in a spaced apart relationship with the flow exposed temperature sensor and the disk so as to be isolated from the flow, at least to an approximation, to produce a reference output signal for comparison with the sensor output of the flow exposed temperature sensor. The reference temperature sensor may be protected by a housing from at least a portion of the flow to which the reference temperature sensor would otherwise be exposed.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be illustrative rather than limiting.

FIG. 1 is a partially cut-away, diagrammatic plan view of a disk drive, shown here to illustrate the installation of one or more temperature sensors for use in sensing the gas pressure environment to which the disk drive is exposed.

FIG. 2 is a still further cut-away, diagrammatic plan view of the disk drive of FIG. 1, shown here to illustrate another installation of temperature sensors for sensing the gas pressure environment.

FIGS. 3a and 3b illustrate housing arrangements that may be used with the temperature sensors of the disk drive of FIGS. 1 and 2.

FIG. 4 is a graph of empirical results for temperature sensor resistance versus time testing of a particular temperature sensor used as a flow exposed sensor in the implementation of FIG. 1.

FIG. 5 is a graph derived from the empirical results corresponding to the data that was used to generate FIG. 4, but further illustrating percent change in sensor resistance versus time.

FIG. 6 is a graph illustrating normalized modeling results that are based, at least in part, on the measured values seen in FIG. 4 for various elevations.

FIG. 7 is a block diagram illustrating a system including a sensing arrangement based on flow induced disk rotation that may be used to sense the elevation of a disk drive.

FIG. 8 is a flow diagram illustrating one method, by way of example, for operating the system of FIG. 7.

FIG. 9 is a diagrammatic view, in perspective, of a sensor extension including an arrangement of panels that can fold into a sensor housing.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiment shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology such as, for example, upper/lower, right/left, front/rear top/bottom, underside and the like has been adopted for purposes of enhancing the reader's understanding, with respect to the various views provided in the figures, and is in no way intended as being limiting.

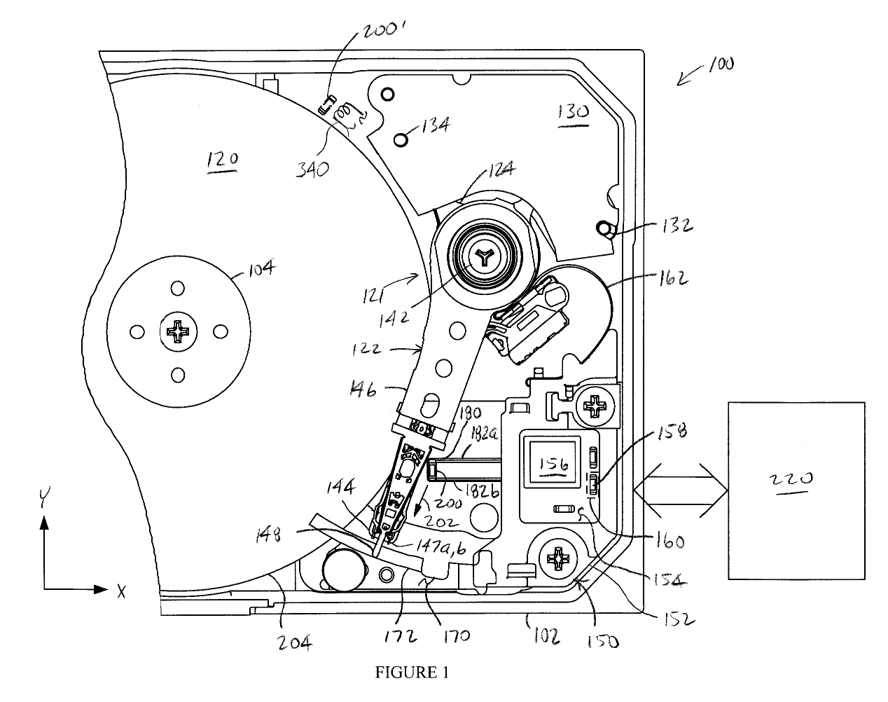

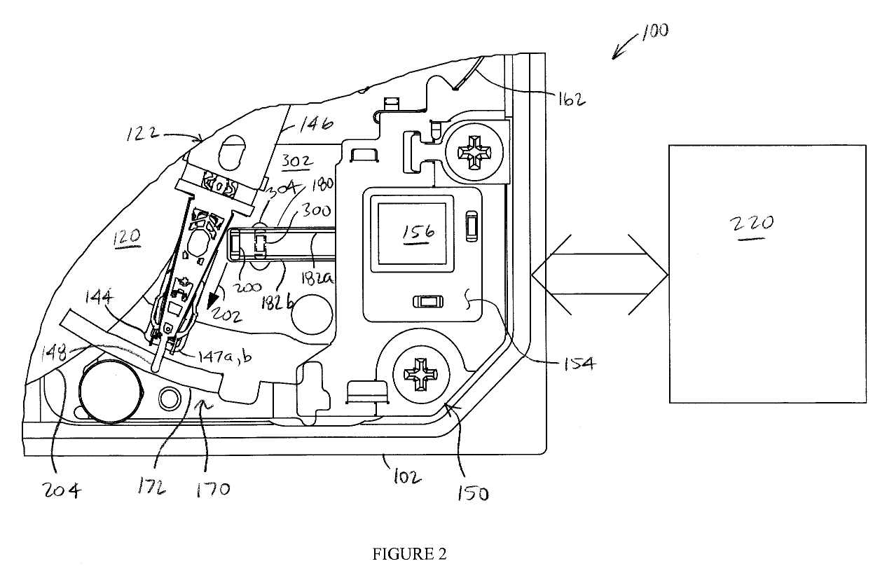

Turning now to the figures, wherein like components are designated by like reference numbers whenever practical, attention is immediately directed to FIG. 1 which diagrammatically illustrates a hard disk drive, produced in accordance with the present invention, and generally indicated by the reference number 100. Drive 100 has been illustrated with its cover removed in order to show the various components which make up the drive. The drive includes a base 102, supporting a spindle motor 104 for use in rotating at least one disk 120. In the present example, a one inch diameter disk is used, however, the use of larger diameter disks is readily accommodated, as will be further discussed at an appropriate point hereinafter. The disk includes opposing major upper and lower surfaces, each of which can be used to store digital data. A head stack assembly (HSA) that is generally indicated by the reference number 121, and which may be referred to hereinafter as an actuator arrangement, includes a head gimbal assembly 122 (HGA) and a VCM end 124 having a voice coil (not visible) that is supported in a magnetic field defined by an assembly that includes a magnet (not visible), a lower return plate (not visible) and an upper return plate 130, all of which will be familiar to those having ordinary skill in the art. It should be appreciated that the teachings herein apply to the use of any suitable number of disks/data surfaces and appropriately configured transducer arrangements. An inner diameter stop pin 132 and an outer diameter stop pin 134 serve to define rotational extents of travel of the HSA by engaging side margins of VCM end 124 at an inner diameter position and an outer diameter position, respectively, and further serve in conducting magnetic flux between the upper and lower return plates. Thus, the voice coil is supported in a magnetic field such that a controlled electric current in the voice coil can be used to selectively change the position of HGA 122. In this regard, the HSA is pivotally supported at a pivot 142. HGA 122, which may be referred to as a transducer arm arrangement, extends outward from pivot 142, at least generally opposite VCM end 124, to a transducer arrangement 144. In the present example, a pair of transducer arms 146 is used such that a first transducer configuration 147a, associated with an upper one of the arms, performs data accesses using an upper surface (visible in FIG. 2) of disk 120, while a second transducer configuration 147b, associated with a lower one of the arms, performs data accesses using a lower surface (not visible in FIG. 2) of disk 120. Generally, each transducer configuration comprises a slider which may support separate read and write transducers in a well known manner. A lift tab 148 extends from the distal end of each of the transducer arms.

With continuing reference to FIG. 1, a flexible circuit assembly 150 includes a bracket 152 and a flexible film 154 that supports a pattern of electrically conductive traces, most of which have not been show for purposes of illustrative clarity. Flexible film 154 supports a number of components including, for example, an integrated circuit 156 and a reference temperature sensor 158. In one embodiment, a housing 160, having a footprint that is indicated by a dashed line, can optionally be used to shelter reference temperature sensor 158 from disk induced flow that may be present at its location. Housing 160 can be formed from any suitable material. It should be appreciated that, in instances where the reference temperature sensor is located at a position that exposes it to heat generating components, the housing can be configured to insulate the reference temperature sensor from these heat generating components, as will be further discussed at an appropriate point below. At this juncture, it should be noted that the use of a reference temperature sensor is not a requirement, as will be further described.

Components, including reference temperature sensor 158, are attached to film 154 in electrical communication with electrically conductive traces in a manner that will be familiar to one having ordinary skill in the art. Flexible film 154 further includes flex extensions, each of which supports an appropriate pattern of electrically conductive traces, for electrically interconnecting the various electrical components within drive 100, as well as for use in externally electrically interfacing the disk drive. Since the general aspects and use of a flexible circuit assembly are well-known, such descriptions have not been provided for purposes of brevity. One example of the aforementioned flex extensions comprises an HGA flexible circuit extension 162 which may also be referred to as a “flex loop”. A latching arrangement, which is not visible, due to the presence of upper return plate 130, can be positioned proximate to VCM end 124 of HSA 121 for use in limiting the potential of the HGA with respect to rotating from an unloaded position to a loaded position in which the transducer configurations or sliders of transducer arrangement 144 come into contact with the data surfaces of disk 120 at an undesired time such as, for example, when the disk is not rotating. It is noted that any suitable latch arrangement may be used, however, one suitable latching arrangement is described in U.S. Pat. No. 5,404,257 which describes an inertial latch configuration.

A ramp arrangement 170 can be used for receiving lift tabs 148 in a manner which will be familiar to one having ordinary skill in the art. It is noted that any suitable ramp arrangement can be used. Such a ramp arrangement defines an opposing pair of surfaces, a visible one of which is indicated by the reference number 172, for engaging the lift tabs to support the transducer arrangement in an unloaded position such that the transducer configurations are remotely located with respect to the disk surfaces. By way of example, one suitable ramp arrangement is described in co-pending U.S. patent application Ser. No. 11/385,955, entitled RAMP ARRANGEMENT FOR A DISK DRIVE AND METHOD, which is commonly owned with the present application and incorporated herein by reference in its entirety.

Still referring to FIG. 1, in one embodiment, flexible circuit arrangement 154 includes a sensor extension 180 that supports a pair of electrically conductive traces 182a and 182b, that are in electrical communication with a processing arrangement that can be located in the drive or in a host device, as will be further described. Traces 182a and 182b are electrically connected to a temperature sensor 200 that is supported by sensor extension 180. It is noted that temperature sensor 200 may be referred to as a flow cooled or flow exposed sensor. The electrical connections between the electrically conductive traces and the flow exposed sensor, as is the case with any component described herein that is connected to electrically conductive traces, can be made in any suitable manner such as, for example, using solder or electrically conductive adhesive. As described above, the disk rotation induced flow is generally relied on for the purpose of causing the slider of each transducer configuration to fly in a spaced apart relationship with the rotating surface of the disk that it confronts, to form an airbearing. In accordance with the present disclosure, a disk rotation induced gas flow 202 (indicated by an arrow and generally a flow of air) is used to cool the flow exposed sensor, as will be further described. In one embodiment, flow exposed temperature sensor 200 can be a thermistor. While a wide variety of thermistors may be employed, characteristics of a thermistor that is representative of a suitable candidate include, but are not limited to, a relatively physically small thermistor that exhibits a relatively fast time constant. Moreover, other forms of temperature sensor may be used including, for example, thermocouples, thermometers, infrared sensors, and the temperature sensitivity of various metals, for instance, platinum (sometimes referred to as RTDs (Resistance Temperature Detectors)). Generally, the reference sensor and flow exposed sensor will be of the same device type, although any suitable combination of device types may be used, so long as appropriately accurate temperature sensing is achieved. In one embodiment, reference thermistor 158 and flow exposed thermistor 200 provide signals to a processing arrangement such as, for example, a processor 220 that can form part of a host device, which host device has not been shown for purposes of illustrative clarity. In this regard, the sensor signal or signals can be handled by any suitable electronic arrangement, in any suitable location, while remaining within the purview of the teachings herein.

With respect to the location of flow exposed sensor 200, any suitable location may be employed which exposes the sensor to the disk rotation induced flow, since the flow is available in many locations proximate to the rotating disk. The illustrated location is proximate to a peripheral edge 222 of the disk and may be as near as possible thereto without actually contacting the disk. In this regard, areas of relatively higher flow rate will enhance the cooling effect that is provided by the flow. It is not required to use flexible film 154 to support the sensor, so long as the flow exposed sensor is located at a position in drive 100 which, at least approximately at the operational rotational velocity of the disk, subjects sensor 200 to disk rotation induced gas flow 202. Of course, suitable electrical connections to the sensor are made. In this regard, a flow exposed sensor 200′ is indicated at another suitable location proximate to the periphery of disk 120. While FIG. 1 is a plan view, showing what are generally characterized as the X and Y dimensions, in the present example, the Z height position (normal to the X and Y plane) of temperature sensor 200 (or 200′) can be approximately in the plane of disk 120 where a single disk is used. Where a stack of disks is used, it may be useful to locate the flow cooled temperature sensor approximately centered, adjacent to the thickness of the disk stack. Again, any other location is suitable so long as the temperature sensor is sufficiently subjected to the disk rotation induced flow.

In embodiments that use a reference temperature sensor, it may be useful to use a reference sensor that is substantially the same part as the flow exposed sensor, such that the two sensors exhibit essentially the same thermal response characteristics and, therefore, will generate signals that track one another when exposed to the same thermal environment. In this way, differences between their signals are more likely to be attributable to the presence of the cooling airflow at the flow exposed sensor. It should be appreciated that, in an embodiment where the reference temperature sensor is exposed to a heat generating component, compensation may be provided in order to cancel out the effect of the heat generating component, at least from a practical standpoint.

Referring to FIG. 2, disk drive 100 is illustrated in a still further cut-away view having a modified sensing arrangement in which a reference temperature sensor 300 is located on sensor extension 180. In one embodiment, sensor 300 can be on an opposite side of the flex extension with respect to flow exposed sensor 200. Accordingly, reference sensor 300 is shown in phantom, using dashed lines. It should also be appreciated that reference sensor 300, at this location, would likely be subjected to less disk induced gas flow 202 than the flow exposed sensor. Any suitable provision may be used in order to further protect or isolate the reference sensor from this gas flow. In one embodiment, a base plate 302, beneath the reference sensor, in the current view, can form a recess 304 (only partially visible in the view of the figure) that receives the reference sensor. Any suitable arrangement may be used in order to position the reference sensor within this recess, while appropriately positioning flow exposed sensor 200. In one feature, flex extension 180 can be shaped in a way that affords protection to the reference sensor and which can cooperate with recess 304 to position the reference sensor therein. In one embodiment, tabs on the flex extension can be bent to form a housing around the reference sensor to cooperate with recess 304 to protect the reference sensor from disk induced flow. In another embodiment, a housing can be used without a recess in the base plate. Such a housing can be formed from the flex extension or separately formed. In this regard, such a flex-based housing might appear as being similar to housings that are described below and shown in subsequent ones of the figures. In one feature, the housing can serve as a foot which supports sensor extension 180 against base plate 302. While recess 304 and reference sensor 300 are shown as laterally offset from flow exposed sensor 200 for illustrative clarity, they can be moved to any suitable location including, for example, directly opposite flow exposed sensor 200.

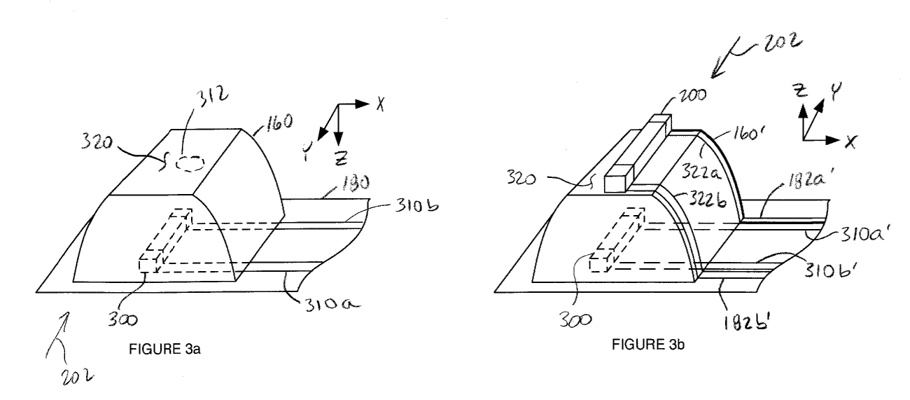

Referring to FIG. 3a, an underside, perspective view of sensor extension 180 is shown including reference sensor 300 and housing 160. Electrical connections are formed to the reference sensor using electrically conductive traces 310a and 310b. It is noted that this housing is suitable for use on sensor extension 180, on flexible circuit assembly 150 (see FIG. 1) or at any other suitable location of the reference sensor. When the sensor housing is separately formed and attached to the flexible circuit assembly or sensor extension 180, it can be attached in any suitable manner such as, for example, using adhesive, interlocking features on the flexible circuit and/or appropriate fasteners. A pressure equalization opening 312 can be formed, for example, in a leeward side of the housing with respect to the disk induced flow, if needed. The need may be based, for example, on the quality of seal or attachment of the housing to the sensor extension or other supporting surface. The housing can be formed in any suitable manner and from any suitable materials including, but not limited to stainless steel, plastics and aluminum, as well as from sensor flex extension 180 itself. The thermal characteristics of the material that is selected for the housing may depend on its particular application. For example, if there is a nearby heat generating component, the housing material may serve to insulate the reference sensor from such heat. On the other hand, if the housing serves primarily to isolate the reference sensor from the disk induced flow, it may be formed from a thermally conductive material for purposes of maintaining the temperature of the reference sensor as close as possible to temperature of the flow exposed sensor, not accounting for flow induced cooling of the flow exposed sensor. A housing may be provided with different thermal characteristics on different sides. For example, if one side confronts a heating generating component, as may be the case with the reference sensor of FIG. 1, the confronting side may be configured to provide higher thermal isolation, for instance, by being thicker or by being formed from a material having enhanced thermal isolation qualities. In another embodiment, an additional thermal isolation layer may be attached, for example, by using an adhesive, only to the side or sides of the housing that confront a heat generating component. A surface 320 of housing 160 can serve as a foot that is attached to and/or biased against base plate 302 or some other suitable surface in the disk drive. Any suitable shape may be used for the housing and the illustrated shape in the figures is not intended as being limiting.

Referring to FIG. 3b, a modified housing 160′ is illustrated. Housing 160′ is supported, in this example, on the upper surface of sensor extension 180 (as is shown by an XYZ coordinate axes indication) and houses reference sensor 300 therein, in the manner that is described with respect to FIG. 3a, electrically connected with electrically conductive traces 310a′ and 310b′ which are essentially identical with aforedescribed traces 310a and 310b, other that being located on an opposing major surface of sensor extension 180. Housing 160′, however, supports electrically conductive traces 322a and 322b which extend onto surface 320 of the housing and are in electrical communication with flow exposed sensor 200 as well as traces 182a′ and 182b′. Traces 322a and 322b may be formed in any suitable manner, as will be appreciated by one having ordinary skill in the art, in view of this overall disclosure. Further, flow exposed sensor 200 can be electrically connected to the traces in any suitable manner such as, for example, by soldering or electrically conductive adhesive and may be attached directly to housing surface 320 in an suitable manner such as, for example, by using an adhesive. By using the arrangement of FIG. 3b, as is likewise the case with the arrangement of FIG. 2, both the reference sensor and flow exposed sensor are located in close proximity to one another so as to enhance the likelihood that a difference in their outputs is attributable to the gas flow to which the flow exposed sensor is subjected.

Having described the components of disk drive 100 in detail above, a description of the operation of the system will now be provided with respect to the use of a flow exposed sensor and a reference sensor. As noted above, the flow exposed sensor is positioned in flow 202. It should be appreciated that this flow can exhibit a variety of characteristics and remain useful, so long as it is capable of carrying heat away from the flow exposed sensor. These characteristics can include, for example, turbulence and laminar flow attributes. What is significant is that the flow is capable of carrying increasingly less thermal energy away from the flow exposed temperature sensor with decreasing in-drive pressure. In the example of a particular thermistor, the resistance of the thermistor increases as the temperature of the thermistor decreases, in an inverse functional relationship. While the example herein utilizes a thermistor with a negative temperature coefficient, it should be appreciated that thermistors are available with either positive or negative coefficients and the present example is not intended as being limiting. Accordingly, across this thermistor, a decrease in temperature results in an increased resistance. If a fixed current is applied to the thermistor that is sufficient to raise its temperature, through Joule heating, above the surrounding area by some sufficient amount, then it is recognized that it will lose heat to the surrounding, cooler area. It is recognized that the heat carrying capability of the flow changes in direct proportion to the density of the air and the velocity of its movement in the drive. Thus, for a fixed current through the thermistor, the voltage in a flow exposed thermistor will change in direct relation to the air density, for a given in-drive temperature, thereby producing a pressure sensitive signal. It should be appreciated that this pressure sensitive signal is advantageously sensitive to any factor that influences a change in the in-drive air density including, for example, elevation, temperature and barometric pressure. It is noted that temperature sensors such as RTDs, thermocouples and thermistors can be operated for self-heating whereas some other types of temperature sensors are not self heating. For temperature sensors that are not self-heating when in operation, other methods and devices can be used to elevate the temperature of the sensor or the area that it is measuring can be elevated above the surrounding area to, in turn, heat the sensor. For example, a heating device 340 (see FIG. 1) is positioned proximate to sensor 200′. It is noted that the heating device is illustrated as a coil, however, this is not a requirement. In one embodiment, for a thermometer or infra-red sensor, a heating coil can be used as device 340 to increase the temperature of the measured area so that it will cool down in response to the flow. In another embodiment, an infra-red emitter, such as an IR LED, one example being a Fairchild Semiconductor QED234 LED, can be used as device 340 to heat the sampled area above the surrounding area. This separate heater can also be used in conjunction with self-heating sensors, if desired. Referring briefly to FIG. 2, recess 304 can be configured to accommodate a heating device, if so desired. It should also be appreciated that a sensor can be arranged adjacent to a heat generating component expressly for the purpose of providing an effect that mimics self-heating.

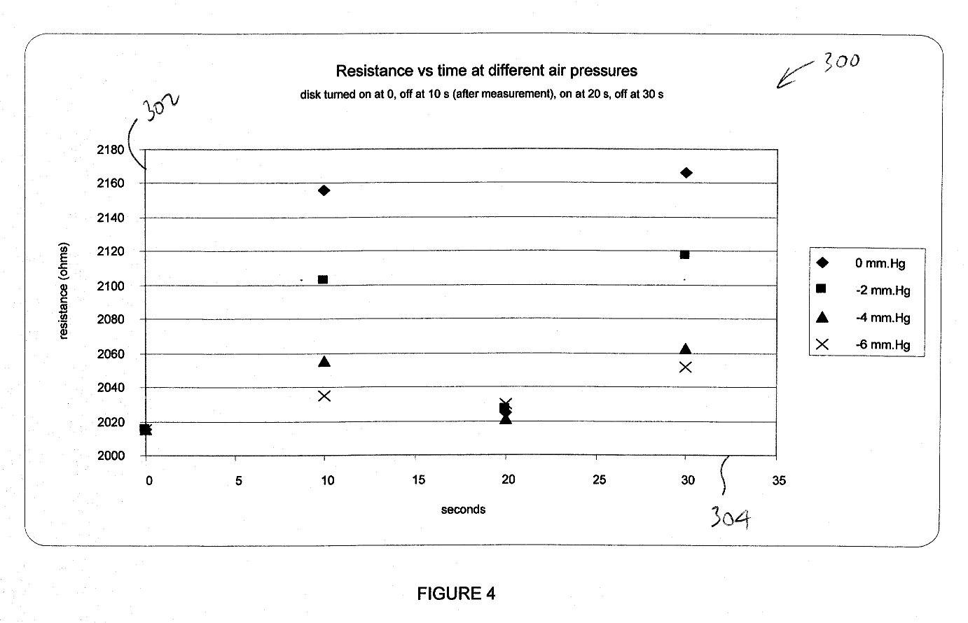

Turning now to FIG. 4, a graph is generally indicated by the reference number 300 which shows a vertical, resistance axis 302 vs. a horizontal, time axis 304. The values that have been plotted represent empirical results that were obtained using a thermistor that is positioned, at least approximately, at the position of thermistor 200 shown in drive 100 of FIG. 1. In this regard, however, the thermistor that was used was an off-the-shelf GE Industrial Systems DC95F202W. It should be appreciated that this part is relatively large physically and exhibits a time constant that is relatively long. At the same time, even this thermistor demonstrated the effectiveness of the concepts that have been taught herein. Sensors with shorter time constants would, therefore, be expected to produce faster responses. Further, the data is taken at single, relatively widely separated time intervals and does not illustrate what would be expected to be exponential behavior in terms of a continuous response, as will be further discussed. Resistance values versus time were established by subjecting the drive to a number of different pressures, corresponding to increasing elevation, starting with a first set of data points that are designated with a diamond shape and correspond to approximately 0 feet (sea level, 0 mm Hg); a second set of data points, designated by a square shape, corresponding to approximately 5,000 feet (˜−2 mm Hg); a third set of data points, designated by a triangle shape, corresponding to approximately 10,000 feet (˜−4 mm Hg); and a fourth set of data points, designated by an “X”, corresponding to approximately 15,000 feet (˜−6 mm Hg), thereby representing a significant elevation. The various pressures were produced using pressure and vacuum producing arrangements, as necessary, since the ambient pressure was that of the elevation of Longmont, Colorado. In order to put these figures into perspective, it is noted that the elevation of Denver, Co is one mile or 5,280 feet. The highest point in Colorado is Mount Elbert at 14,433 feet, whereas the highest point in North America is Mount McKinley, Alaska, at 20,320 feet. As a further point of interest, the average elevation of the North American continent is about 2,200 feet. Of course, it is recognized that a disk drive can be subjected to high altitude conditions other than through high land elevation including, for example, through aircraft. For example, the cabin pressure, at cruising altitude in a modern commercial jetliner, is generally held around 7,000 feet.

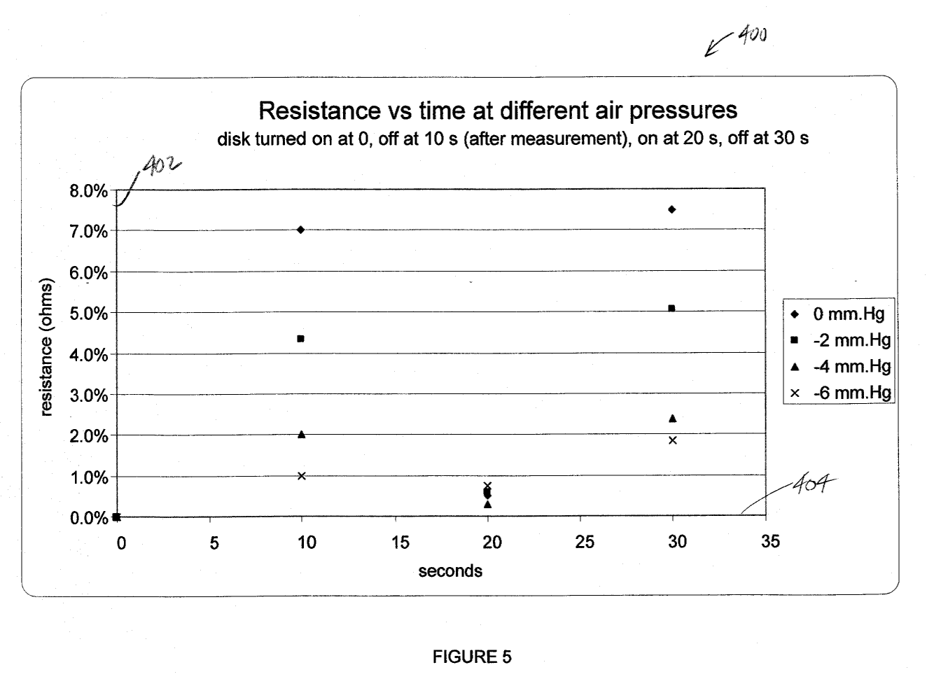

Still considering FIG. 4, in order to demonstrate that the measurement results are indeed responsive to disk 120 spinning, spindle motor 104 was started and stopped at various times. At t=0, the resistance was measured and the spindle motor was started. It is noted that this particular spindle motor/disk combination reaches operational speed in approximately milliseconds, so that the illustrated response is essentially independent of the spin-up time. At t=10 seconds, the resistance was measured and then immediately the spindle motor was turned off and allowed to stop. Again, the disk stops in a matter of milliseconds, so that the illustrated response is essentially independent of the spin-down time. At t=20 seconds, the resistance was measured and the spindle motor started. Note that between t=10 seconds and t=20 seconds, the sensor had not completely returned to its original resistance value, corresponding to the value at t=0, which demonstrates the effect of its time constant. At t=30 seconds, the resistance was measured again. FIG. 5 is a plot, generally indicated by the reference number 400, which illustrates percent change in resistance along a vertical axis 402 versus time, along a horizontal axis 404, for the same set of data that was used to generate plot 300 of FIG. 4. At t=0, it is apparent that the data points for all four elevations coincide, since there is no disk induced airflow. At t=10, the data points nearly coincide, where the offset that is present can be attributed to the time constant of the thermistor that was employed. This figure demonstrates more that acceptable results for each of the measured values at t=10 and t=30 seconds for purposes of establishing the elevation of the disk drive with a minimum change in resistance at −6 mm Hg (15,000 feet) of approximately 1 percent. Moreover, for t=10 and t=30, the points corresponding to the various elevations are vertically spaced apart in the figure (likewise seen in FIG. 4) and well differentiated in a manner that is consistent with the elevations to which they correspond. That is, the percent change of resistance reduces with increasing elevation, but the function becomes increasingly nonlinear with increasing elevation. The elevation, however, at which the percent change becomes essentially indiscernible corresponds to an elevation that is sufficiently high, so as to be well above the practical elevation at which consumer hard disk drives are generally designed to operate.

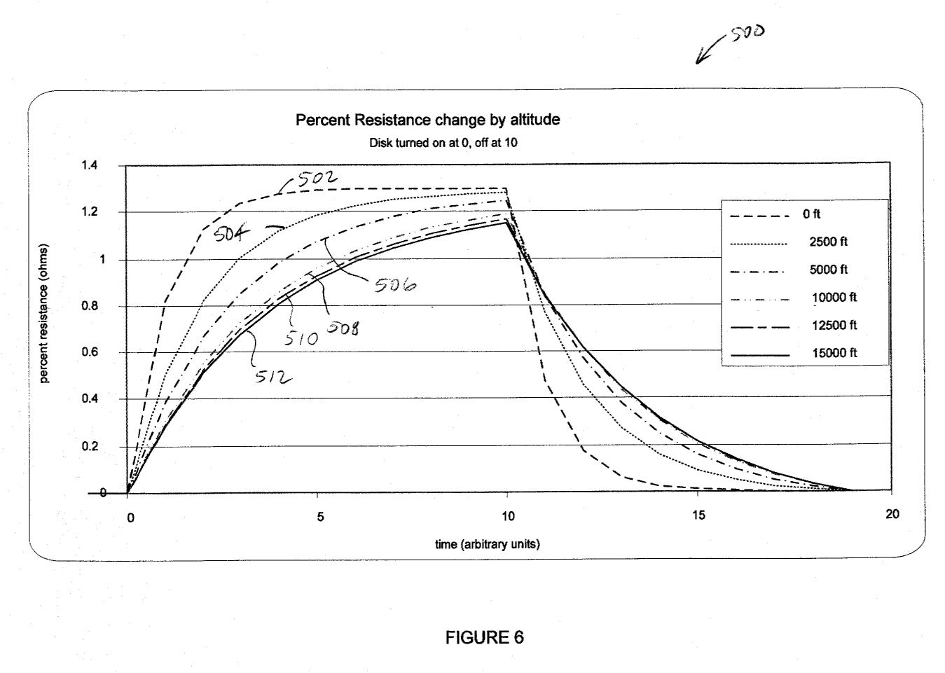

Turning to FIG. 6, a graph is generally indicated by the reference number 500 which shows percent change in resistance along a vertical axis versus time along a horizontal axis. A first plot 502 corresponds to approximately 0 feet (sea level); a second plot 504 corresponds to approximately 2,500 feet; a third plot 506 corresponds to approximately 5,000 feet; a fourth plot 508 corresponds to approximately 10,000 feet; a fifth plot 510 corresponds to approximately 12,500 feet; and a sixth plot 512 corresponds to approximately 15,000 feet. At t=0, the disk begins rotating whereas at t=10, the spindle motor is turned off. It is noted that the plots in this figure represent normalized modeling results that are based on the measured values seen in FIG. 4. Responsive to changing the rotation status of the disk, the sensor output changes rapidly and, at least approximately exponentially, approaches a steady state value. It should be appreciated that the sensor output is sufficiently rapid so as to detect even the most rapid elevation changes to which the drive may reasonably expect to be subjected, thereby providing for corresponding adjustment of fly height or other appropriate response. Of course, there is an upper limit in elevation above which the slider of a disk drive is not capable of flying. Detection of such a high elevation may be used to trigger unloading the heads until conditions once again are favorable for flying. In state-of-the-art drives, this elevation limit may be encountered at approximately 15000 ft. It is noted that the model that was used to generate the plots of this figure predicted smaller effects than those actually observed. The figure, therefore, is intended to illustrate the exponential behavior that is expected over time.

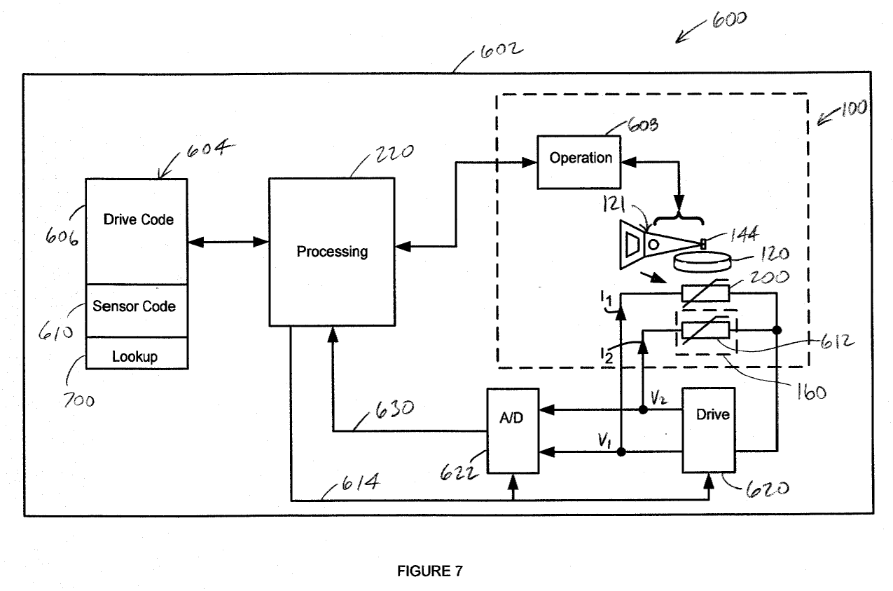

Referring to FIG. 7, a system is generally indicated by the reference number 600, including hard drive 100 installed in a host device 602. The host device includes processor 220 which is interfaced with a memory 604 that includes drive code 606 for executing the operation of drive 100 via an operations section 608 and sensor code 610 for use in monitoring flow exposed sensor 200 and a suitably arranged reference sensor 612, in accordance with the foregoing descriptions. In one embodiment, the reference sensor may be located in housing 160 of FIG. 3a. In the present example, when it is desired to establish the elevation, as well as any influence of characteristics having a similar influence, processor 220 uses a line 614 to cause a drive section 620 to provide a current I₁ to flow exposed sensor 200 and a current I₂ to reference sensor 612. The two currents can be essentially identical, although this is not a requirement. An Analog to Digital (A/D) converter 622 is interfaced with processing section 220 for control purposes and is caused to read voltages V₁ and V₂ that are produced across the flow exposed and reference sensors, respectively. These voltages are digitized by A/D 622 and conveyed to processing section 220 on a line 630. It is considered that it is within the capability of one having ordinary skill in the art to configure drive section 620 and A/D converter 622 in view of this overall disclosure. While the present example utilizes a current source to drive the sensors, this is not a requirement and, in another embodiment, a known voltage can be applied with the current as the unknown variable.

Having described system 600 in detail above, the air pressure/elevation can be measured at any time. Current source 620 can be selectively energized, or be energized continuously. With continuing application of currents I₁ and I₂ self-heating of the thermistors will result and, with the use of negative temperature coefficient thermistors described above, the resistance of the thermistors will decrease. If the disk is not spinning, then substantially identical thermistors should reach the same value of resistance, assuming that they are exposed to an identical thermal environment. If the disk is spinning, then R_{FE} (the temperature of the flow exposed sensor) should stabilize at a higher resistance than the R_{REF} (the resistance of the flow protected or reference thermistor) for a negative temperature coefficient. In one embodiment, the resistance difference between the flow exposed thermistor and the reference thermistor is measured in an altitude chamber at various air pressures before the drive is shipped and this information stored in a lookup table 700 (see FIG. 7). From this, the air pressure is known and appropriate measures can be taken by the drive. For example, fly height adjustment can be performed where fly height settings can be tabulated in the lookup table.

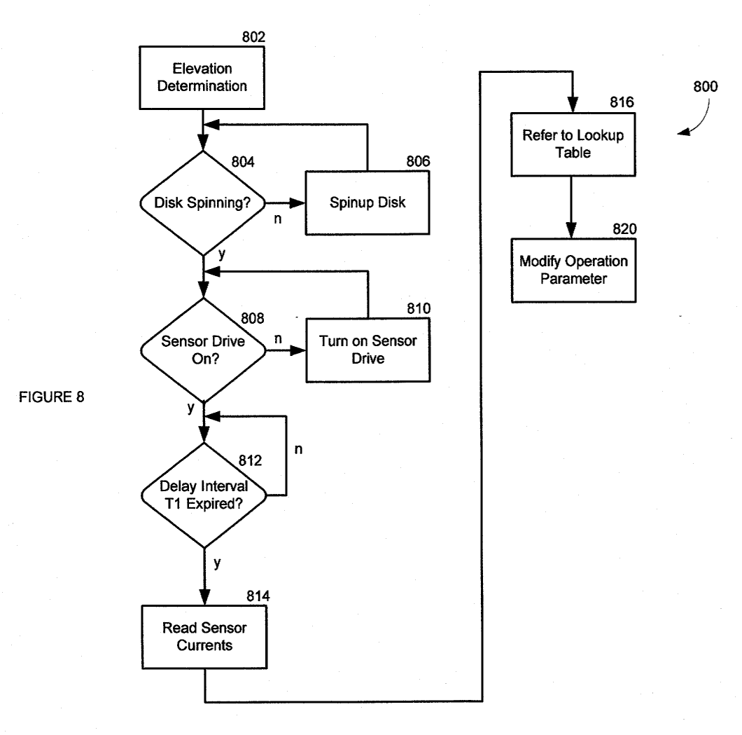

FIG. 8 is a flow diagram that illustrates one exemplary manner of operation, generally indicated by the reference number 800, for a system using both a reference sensor and a flow-exposed sensor such as, for example, system 100 of FIG. 6. The process begins at 802. At 804, a test is made to determine whether disk 120 is spinning. If not, step 806 starts the disk spinning. At 808, a determination is made as to the status of sensor drive section 620. If the sensor drive is off, step 810 actuates the sensor drive. If, on the other hand, the sensor drive is on, step 812 can impose a time delay interval T1 that provides for stabilization of the disk spin and for pre-heating the sensors, as necessary. Once T1 expires, step 814 reads the sensors. Using the sensor readings, step 816 refers to the lookup table and associates the sensor readings with the closest values in the table and may extrapolate between values, if desired. In one embodiment, where the sensor measurements fall between elevation values that are set forth in the lookup table, the default value can be selected as the table value corresponding to the nearest higher elevation. At 820, at least one operational parameter can be modified based on the determination of step 816. For example, the DFH actuation of the transducers in the head arrangement can be adjusted. As another example, the heads can be unloaded from the disk or parked when the elevation is determined to be sufficiently high so as to preclude safe disk access operations. The lookup table may contain any suitable parameters including, but not limited to elevation, reference sensor resistance, flow exposed sensor resistance, disk drive parameter values such a fly height setting, a setting that instructs to unload the heads and park the actuator, and any other suitable value, including values that are derived from the foregoing.

It should be appreciated that an embodiment that uses a flow exposed sensor without a reference sensor operates generally accordance with FIG. 8, but uses a more simplified version of a lookup table in which the only variable is the output of the flow exposed sensor.

In one embodiment, the sensors are initially measured without the disk spinning and after some time period sufficiently long that they are stabilized. The disk is then spun up and the sensors are continuously or at least frequently measured. The flow-exposed sensor resistance will change at a rate faster than the non flow-exposed sensor. The rate of change can be correlated similarly as before and recorded in a lookup table along with appropriate operational parameter adjustments required.

Referring briefly to FIGS. 4 and 5, the data that is set forth in these figures was empirically produced using the flow exposed sensor, as shown at the location in FIG. 1, with a one inch diameter disk. It should be appreciated that a one inch diameter disk is near the smallest disk diameter that has been commercially developed to date and of which Applicant is aware. Accordingly, the amount of disk induced flow from a one inch diameter disk is far less than that which would be generated by larger diameter disks. The use of larger diameter disks would result in still further enhanced performance with respect to elevation determination. Accordingly, the teachings herein enjoy applicability with respect to all hard disk drives of which Applicant is aware and are most likely to be applicable to virtually all future hard disk drives.

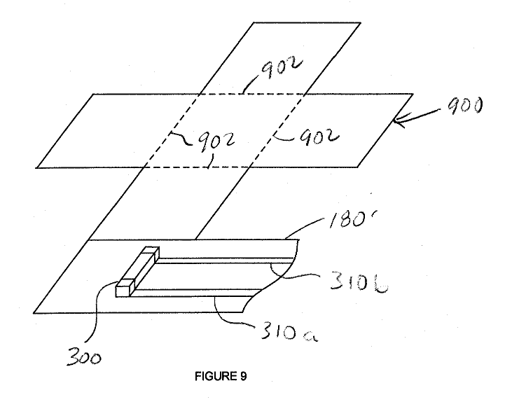

Attention is now directed to FIG. 9 which illustrates a partial, diagrammatic view of a flexible sensor extension 180′, in perspective, supporting reference sensor 300. Extension 180′ includes a foldable arrangement of panels 900 that can be folded along dashed lines 902 so as to form a housing around reference sensor 300. It should appreciated that the foldable panels can be arranged in a variety of ways while still providing for the capability to fold into a housing. The present example, therefore, is not intended as being limiting. Of course, a pressure equalization opening or openings can be formed in selected ones of the panels, as desired.

Although each of the aforedescribed physical embodiments have been illustrated with various components having particular respective orientations, it should be understood that the present invention may take on a variety of specific configurations with the various components being located in a wide variety of positions and mutual orientations. Furthermore, the methods described herein may be modified in an unlimited number of ways, for example, by reordering the various sequences of which they are made up. Accordingly, having described a number of exemplary aspects and embodiments above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. In a disk drive having a disk that is supported for rotation in a housing and having at least one major surface for use in storing data, and a slider supported for movement, in said housing, relative to the major surface area, including a transducer arrangement on the slider for use in performing disk accesses in one or both of a write operation to write data to the disk and a read operation to access data from the disk and where said slider is configured for flying in a spaced apart relationship with the major surface during said disk accesses based on a gas environment that is present in said housing, which gas environment can change in pressure such that a fly height of the slider changes with the pressure change in the gas environment, an apparatus comprising:
a temperature sensor positioned proximate to said disk such that the rotation of the disk creates a flow in said gas environment to which the temperature sensor is exposed, and which flow changes at least in proportion to the pressure change in the gas environment, to produce a sensor output that is responsive to said pressure change in the gas environment.

2. The apparatus of claim 1 wherein said disk includes an outer peripheral edge and wherein said temperature sensor is located adjacent to said outer peripheral edge.

3. The apparatus of claim 2 wherein the disk defines a disk plane and wherein said temperature sensor is positioned outward of said outer peripheral edge and at least approximately in said disk plane.

4. The apparatus of claim 1 wherein said slider supports the head arrangement having a magnetic spacing adjustment for selectively adjusting a magnetic spacing between the head arrangement and the major surface for any given fly height of the slider and including a control arrangement for receiving the sensor output and for changing said magnetic spacing adjustment based on said sensor output.

5. The apparatus of claim 4 wherein said control arrangement is configured for changing the magnetic spacing adjustment, responsive to the pressure change, to cause the magnetic spacing to be more constant, with respect to the major surface, than the fly height of said slider from the major surface with rotation of said disk.

6. The apparatus of claim 1 wherein said temperature sensor is a thermistor.

7. The apparatus of claim 1 wherein said disk drive includes a head stack assembly that supports said slider, and thereby said head arrangement, for pivotal movement to perform said disk accesses and a flexible circuit assembly having at least one flexible circuit extension that is electrically connected to the head stack assembly and in electrical communication at least with said head arrangement and wherein said flexible circuit assembly includes another flexible circuit extension in electrical communication with said temperature sensor and supporting the temperature sensor in said flow proximate to said disk.

8. The apparatus of claim 1 wherein the aforementioned temperature sensor serves as a flow exposed temperature sensor and further comprising:
a reference temperature sensor placed proximate to said flow exposed temperature sensor and said disk so as to be isolated from said flow, at least to an approximation, to produce a reference output signal for comparison with the sensor output of the flow exposed temperature sensor.

9. The apparatus of claim 8 wherein said reference temperature sensor is a thermistor.

10. The apparatus of claim 8 including a housing for protecting the reference temperature sensor from at least a portion of said flow to which the reference temperature sensor would otherwise be exposed.

11. The apparatus of claim 8 wherein the flow exposed temperature sensor and the reference temperature sensor are characterized by a substantially identical thermal response.

12. In a disk drive having a disk that is supported for rotation in a housing and having at least one major surface for use in storing data, and a slider supported for movement, in said housing, relative to the major surface area, including a transducer arrangement on the slider for use in performing disk accesses in one or both of a write operation to write data to the disk and a read operation to access data from the disk and where said slider is configured for flying in a spaced apart relationship with the major surface during said disk accesses based on a gas environment that is present in said housing, which gas environment can change in pressure such that a fly height of the slider changes with the pressure change in the gas environment, a method comprising:
positioning a temperature sensor proximate to said disk such that the rotation of the disk creates a flow in said gas environment to which the temperature sensor is exposed, and which flow changes at least in proportion to the pressure change in the gas environment, to produce a sensor output that is responsive to said pressure change in the gas environment.

13. The method of claim 12 wherein said disk includes an outer peripheral edge and said positioning locates said temperature sensor adjacent to said outer peripheral edge.

14. The method of claim 13 wherein the disk defines a disk plane and wherein said positioning locates the temperature sensor outward of said outer peripheral edge and at least approximately in said disk plane.

15. The method of claim 12 wherein said slider supports the head arrangement having a magnetic spacing adjustment for selectively adjusting a magnetic spacing between the head arrangement and the major surface for any given fly height of the slider and said method includes changing said magnetic spacing adjustment based on said sensor output.

16. The method of claim 15 including using a control arrangement for changing the magnetic spacing adjustment, responsive to the pressure change, to cause the magnetic spacing to be more constant, with respect to the major surface, than the fly height of said slider from the major surface with rotation of said disk.

17. The method of claim 12 including providing a thermistor as said temperature sensor.

18. The method of claim 12 wherein said disk drive includes a head stack assembly that supports said slider, and thereby said head arrangement, for pivotal movement to perform said disk accesses and a flexible circuit assembly having at least one flexible circuit extension that is electrically connected to the head stack assembly and in electrical communication at least with said head arrangement and configuring said flexible circuit assembly to include another flexible circuit extension in electrical communication with said temperature sensor which supports the temperature sensor in said flow proximate to said disk.

19. The method of claim 12 wherein the aforementioned temperature sensor serves as a flow exposed temperature sensor and further comprising:
arranging a reference temperature sensor proximate to said flow exposed temperature sensor and said disk so as to be isolated from said flow, at least to an approximation, to produce a reference output signal for comparison with the sensor output of the flow exposed temperature sensor.

20. The method of claim 19 including providing a thermistor as said reference temperature sensor.

21. The method of claim 19 wherein the flow exposed temperature sensor and the reference temperature sensor are characterized by a substantially identical thermal response.

22. The method of claim 20 including configuring a housing to protect the reference temperature sensor from at least a portion of said flow to which the reference temperature sensor would otherwise be exposed.
